(19) United States
(12) Patent Application Publication
(10) Pub. No.: US 2002/0091740 A1
(43) Pub. Date: Jul. 11, 2002

(54) Electronic publishing method and system

(76) Inventor: Curtis Schantz, Kelowna (CA)

Correspondence Address: THOMPSON & KNIGHT, L.L.P., PATENT PROSECUTION GROUP, 1700 PACIFIC AVENUE, SUITE 3300, DALLAS, TX, 75201, US

(21) Appl. No.: 09/755,293

(22) Filed: Jan. 5, 2001

(51) Int. Cl. G06F 15/00

(52) U.S. Cl. 707/530

(57) ABSTRACT

A method of electronically publishing. Information is received. The information is transformed into an MVR document. The MVR document is stored on a document server. The MVR document is sent to a recipient.

### FIELD OF THE INVENTION

An electronic publishing system relates to the field of electronic publishing.

### BACKGROUND OF THE INVENTION

With the success of the Internet and PC's in general, there is considerable demand for delivery and presentation of information in a strictly electronic format, with features beyond the capabilities of today's technologies.

A key problem with prior technologies is that the computer screen is unable to match the ability of paper to display large quantities of information and has degraded the interface by which people must view their data.

Information is displayed on the computer primarily through two standards: HTML (Hypertext Markup Language) and PDF (Portable Document Format). HTML can be considered a page description language. HTML verbosely instructs the browser on what information should appear on the page and how that information should appear (e.g., size and approximate location). The result varies greatly from browser to browser and PC to PC, typically resulting in pages that don't maximize the potential of the available display technology and convey much less information than the printed page—HTML compromises presentation quality in favor of adapting to the display device. PDF files contain an almost perfect duplication of the printed page, but that necessitates a scrolled presentation and files that are very large without the ability to update items on a page PDF compromises presentation quality by adapting to the display content.

There is a clear need for a presentation interface that displays selected information, adapted to the capabilities of the displaying computer, in a page-like interface without scrolling, from compact files that can be quickly updated via the Internet.

There are several significant technical obstacles to solving this problem:

Screen Resolution: The difference in resolution (the number of dots on a page) between paper and screen is significant. A typical low quality printer will generate output at 300 DPI (dots per inch) for a total dot count (resolution) of 8½×300×11×300=8,415,000, whereas the greatest number of computers today present 800×600=480,000 dots. The numerous standards for display resolution (e.g. 640×480, 800×600, 1024×768, 1280×960, etc.) all fall far short of the capabilities of print and demand adaptability in the display technology to maximize the potential of the display.

Aspect Ratio: The most common use of paper is in portrait mode (taller than wide) while the computer screen is landscape (wider than tall). There have been a few monitor makers over the years that have tried to address this issue, but the millions of monitors in use today make this a standard that is almost impossible to change.

Quantity of Data: A single piece of paper has the ability to hold vast quantities of information. Without compression, an 8½″×11″ paper at 300 DPI has 8,415,000 dot×3 bytes per dot for color information=25,245,000 (over 24 MB) of data potential. Significantly, paper does not distinguish between its content types i.e. it doesn't care whether it holds a picture or a page full of text.

Caching of Content: In an effort to minimize the cost and time of re-transmitting previously viewed data, HTML browsers have long used page element caching. As each page is retrieved, a local cache file is checked to determine if a current copy of the page element is already available locally. A growing number of pages are now assembled only at time of viewing by page servers, defeating many caching algorithms. The difficulties lie in determining if any element on this custom page (created just for this viewing) has been previously transmitted to the user. PDF's large files cache in their entirety for short periods of time (depends on user settings) and then must be retrieved again.

PDF is a solution where the page format is retained while not addressing display and other issues. In addition, graphic solutions are used to present the page in a graphic to allow display and zoom on a screen. The graphic solutions all suffer from large file sizes, quality issues, update difficulties, and poor presentation without zooming and scrolling.

### SUMMARY OF THE INVENTION

The electronic publishing system is directed to a presentation interface that displays selected information, adapted to the capabilities of the displaying computer, in a page-like interface without scrolling, from compact files that can be quickly updated via the Internet.

The electronic publishing system technology overcomes these obstacles while adding enhancements that today's user reasonably expects, such as searching, sorting and updating. The basic premise of the electronic publishing system is to present a paraphrased version of the page with key items in their intended locations using intuitive means to fill in the missing information. This page is stored not as a single entity, but rather in a database of objects (graphic and text) that are assembled into a page at the time of viewing. This assembled page is optimized to utilize the maximum capabilities of the display device accommodating old and new technology.

### BRIEF DESCRIPTION OF THE DRAWINGS

FIG. 1 depicts a item categorization table.

FIG. 2 shows a screen capture of a free form layout.

FIG. 3 shows a screen capture of a rule-based layout.

FIG. 4 shows a screen capture of a structured layout.

FIG. 5 illustrates stretching of virtual screens to conform to display devices.

FIG. 6 shows an example of pop-up detail.

FIG. 7 depicts a page component updating process.

FIG. 8 depicts a database.

FIG. 9 shows a process spanning disassembly to MVR display.

FIG. 10 shows a networking system for serving MVR documents.

FIG. 11 illustrates a possible MVR file format structure.

### DETAILED DESCRIPTION

Referring now to the drawings, wherein like reference numbers are used to designate like elements throughout the various views, several embodiments of the present invention are further described. The figures are not necessarily drawn to scale, and in some instances the drawings have been exaggerated or simplified for illustrative purposes only. One of ordinary skill in the art will appreciate the many possible applications and variations of the present invention based on the following examples of possible embodiments of the present invention.

The electronic publishing system allows the user to instantly browse print publications in their current full-page format. Print publications are taken in their current full-page look-and-feel, printed form, and placed on the desktop of the consumer's PC in adjusted full-page format that has substantially the same look-and-feel as the current full-page format, where they live as current and updated information, independently of the Internet. Editorial value and integrity of the printed page are maintained. The user can be instantly launched into Internet commerce or receive traditional phone call or visit information. Updates are periodically performed through periodic connection to the Internet. Updates occur quickly and seamlessly.

In one embodiment, each MVR document becomes an icon on the desktop, perfectly positioned for high visibility and frequent use. High-quality catalog pages and product information are able to be printed easily upon demand by the user. The entries of an MVR document are fully searchable. Items included in an MVR document may contain links accessible to the user that link the user to a website. The ultimate user display device can be any display device. For example, a computer monitor, a palm computing device, etc.

A scripting screen control language (SSCL)—like a proprietary HTML—is used. HTML has not easily supported specific positioning, whereas SSCL does support specific positioning. A first example task might be to specify a rectangle to work on. Position a graphic by specifying top left corner point and height and width. Likewise with text by setting x-y starting coordinate, justification, set text margin for that text only, etc. Similarly for justified text or creating a vector drawing from a set of points. A scripted rectangle (theoretically this outline could be any shape) is an “item” that appears on a “page” or “virtual canvas.” The item may be graphic, text, or both. A second example task might be to put an extra rectangle over another rectangle to show a “new” graphic.

Upon final display, only a single “graphic” is displayed. The screen is a “virtual canvas”. The rectangle tool helps define the graphic part-by-part so that it is easier to create and easier to update. That approach is akin to PCL or PostScript.

In a preferred embodiment, the virtual canvas renders a graphic on a display device with a particular granularity. For example, the display device may be 1024×768 pixels. Views on a less granular screen (or analogously, views in a less granular display window) appear as reductions. Fly over zoom IPAD (see below for an explanation of IPAD) typically displays the native-sized item, although this may still be a reduction to the extent necessary to fit the native-sized item on the screen. “Native-sized” is designer-definable. Alternatively, IPAD may be toggled on and off.

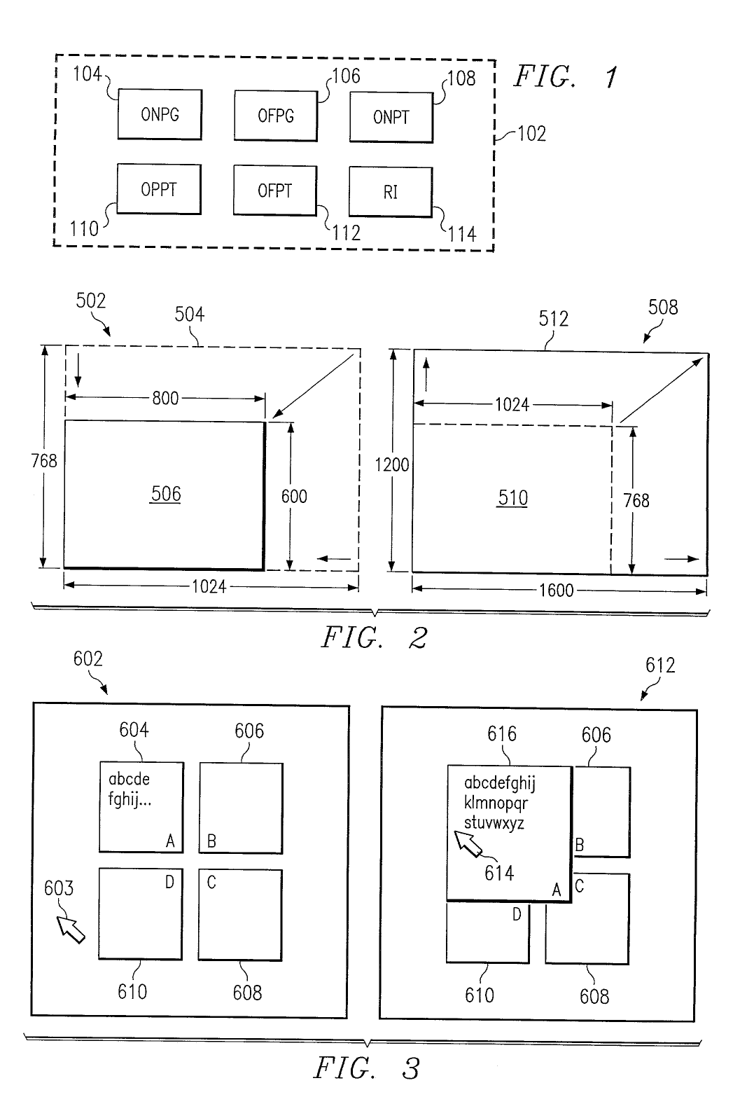

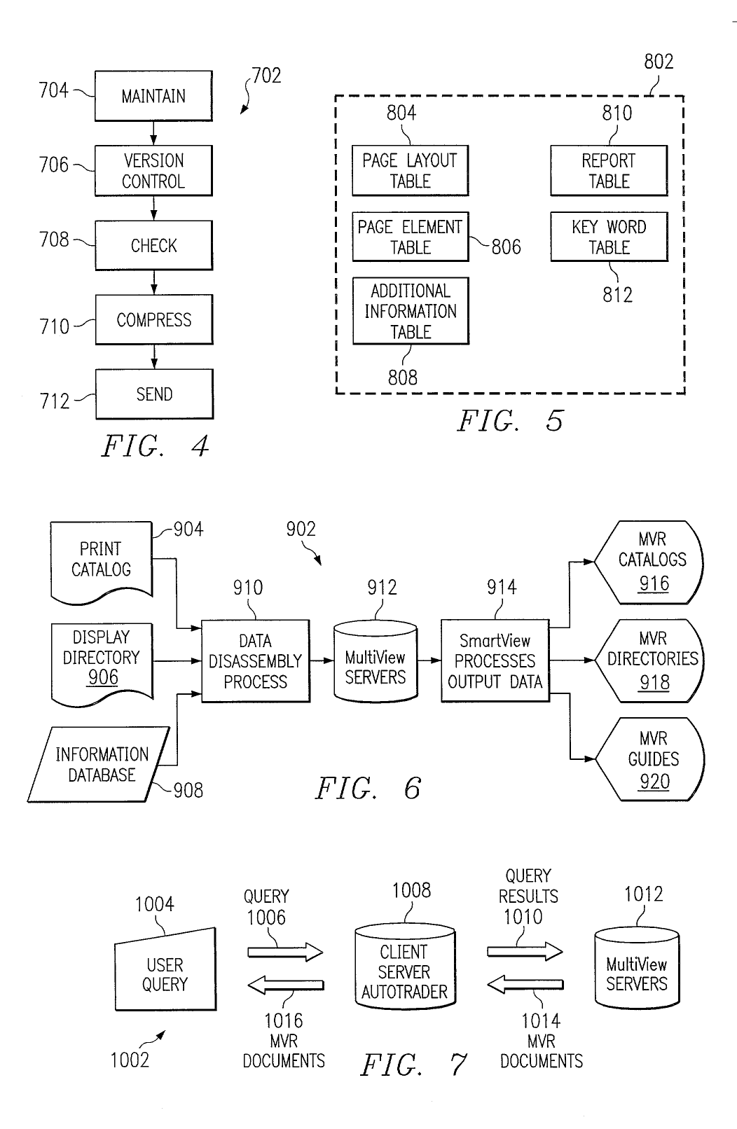

A item categorization table 102, FIG. 1, includes several item categories. The categorization of items into one item category or another is publisher-driven. On Page Graphic (ONPG) 104 includes graphics, which must appear on the page in a given location at a given size ratio relative to the page. The graphics are typically in JPG or PNG format. Off Page Graphic (OFPG) 106 includes graphics that appear as a zoom or additional information and may simply be resizing information for the ONPG. Of course, ONPG and OFPG may, in alternative embodiments, appear in sizes other than a given size ratio, and in locations other than in given locations, depending upon how their context, position, and rules are structured, as applicable.

On Page Text (ONPT) 108 includes text that must appear on the page in a given location with size relative to the page size. Optional Text (OPPT) 110 includes text that may appear on the page if the display technology has the capability to accommodate the text in readable form. Off Page Text (OFPT) 112 includes text that appears in additional information screens. Related Info (RI) 114 includes information that is used to enhance the viewed item; for example, web-links to related information, e-mail links to contacts, extended information beyond OFPT and OFPG.

Pages are assembled at view time using methods defined for the specific content type optimized for the available display area. There are three types of layouts: free form, rule-based, and structured. All three apply to items as well as to pages. For example, a “white pages” style document may have rule-based item assembly (having simple switches for bold, e-mail, etc.) followed by structured page assembly.

Alternatively, pages (virtual canvases) may be assembled substantially prior to viewing time and stored for later viewing. A viewing device may display the pages with access only to the pages and not to the information upon which the page was based.

A free form layout has been created by design and must be duplicated to the best of the abilities of the technology. Typically used for creative catalogs where the items' position, size, and context are very important. The positioning of items on the page is done manually. Note that this could alternatively be moved earlier in the stream of creation by reading in a PDF or Quark file and trying to detect and respect the placement of items on their pages. The key differentiator of free form layouts is that the responsibility for positioning items lies with input provider. A free form layout is characterized by having a “look and feel” which results from a certain amount of creativity and/or design expertise.

Items in free form layout MVR documents may alternatively be positioned on the page in numerous ways. Items may be positioned based on absolute position in the document, proximity to other items in the document, absolute position in the page or virtual canvas, or relative position to other items in the page or virtual canvas. Likewise, the size of items may alternatively be determined and/or specified by absolute size, size relative to the size of the page or virtual canvas, or size relative to other items on the page. The concept of a free form layout can apply equally to the disposition of logical objects within an item.

Similarly, logical objects may be disposed in the item according to manual disposition or according to data obtained by reading from a data file, rules file, or other file.

A rule-based layout defines rules to present structured content according to standards created by author of the data. For example, a “yellow pages” style document has a rule-based layout where the publisher has a method of positioning ads based on size & seniority with primarily textual listings used as filler to complete pages. Importantly, the rule-based layout allows for pagination on the fly to create custom publications.

Further, in rule-based layout, the positioning of items on the page follows rules, so that a query for sets of items can be done and well reassembled. Positioning responsibility is shared between the publisher, who effectively provides the rules, and the electronic publishing system that implements, clearly articulates, and follows those rules. The input provider does not provide positioning information directly, but rather provides it indirectly by approving the rules that will be used to position the items. The concept of a rule-based layout can apply equally to the disposition of logical objects within an item. Typically, the “look and feel” of rule-based layouts may seem somewhat more analytical or structured than that of free form layouts. Rules might alternatively dictate sorting (by one or more available fields), pairing/grouping of two or more items, positioning on a virtual canvas, sizing, and abbreviating of information (determining what information, if any, is treated as overflow not available on the main page).

Items may alternatively be positioned according to various rules. For example, based on descending size, descending seniority (or other assigned characteristic), or combination of factors such as first based on descending size, with ties resolved by descending seniority (or other assigned characteristic). These positioning factors might alternatively also apply to items in structured layout MVR documents. As stated, document and page or virtual canvas layout are analogous to item layout, the elements being laid out in items being logical objects. Therefore, where context allows, description of various alternatives of laying out MVR documents, pages, and/or virtual canvases with items should also apply to laying out items with logical objects.

A structured layout handles content which is sized the same, does not require any context control—so positioning of objects is not important—and can be assembled by following simple sort instructions to assemble pages of desired content in the order desired. Examples of this content type are “white pages” style documents and “Auto Trader” style publications. Proper positioning does not depend on cognizance of what else is on the page, other than filling the page with items. Therefore, context information is not significant. The concept of a structured layout can apply equally to the disposition of logical objects within an item. The “look and feel” of structured layouts tends to be quite analytical and does not typically appear to be characterized by significant creativity.

Note that all items may be designated for disposition and/or display. Alternatively, particular items and/or groups of items may be so designated. For example, items may be selected based on manual user selection, manual designer selection, and/or specific characteristics present in the items. For example, a “residential white pages” type structured document might have its items screened based on a particular last name and/or by city.

The page is assembled to an invisible virtual screen of given size and then stretch drawn to the visible screen. As the image is stretched, it fills the available display area accommodating the varied display sizes and screen resolutions.

Diagram 502 FIG. 5 illustrates virtual canvas 504 being resized from 1024×768 to 800×600 to conform to display device 506. Likewise, diagram 508 depicts virtual canvas 510 being resized from 1024×768 to 1600×1200 to conform to display device 512. This resizing prevents the look of the display from changing like it does in HTML.

Of great importance to the electronic publishing system's technology in overcoming the shortcomings of the display capabilities, is the extensive use of additional information screens that appear on the viewed page. This is called In Page Additional Detail (IPAD). These screens appear without additional clicks or “drill downs” creating an intuitive means to see the more information. The text “OFPT” and graphics “OFPG” used in the IPAD often make use of information in the “ONPT” and “ONPG” reducing duplicated data and file size.

The additional detail information in IPAD may be related, but does not have to be. For example, it might be the same item stretched to a different size, extra information on the item, or a different view of the image. Examples of unrelated information might include advertisements, images, and extra information. IPAD is design controlled, meaning that at the page assembly phase, as the items are being drawn on the virtual canvas, an item map is created with the requisite definition of IPAD zones and specification of IPAD corresponding to each zone.

The IPAD may possibly include additional alternative objects, including notepad link, e-mail link, URL link, e-commerce link, more detailed IPAD, additional IPAD, technical specifications IPAD, etc.

Virtual canvas 602, FIG. 6, shows four IPAD zones defined and labeled A 604, B 606, C 608, and D 610. Cursor 603 is onscreen, but does not float over any of the IPAD zones. Virtual canvas 612 shows the result of cursor 614 floating over IPAD zone A 604: IPAD zone A 604 is replaced by IPAD A 616 (the IPAD display associated with IPAD zone A 694). In this case IPAD A 616 contains much more detailed information than IPAD zone A 604. IPAD zones B 606, C 608, and D 610 remain unchanged.

When the cursor is at a particular coordinate, that is checked against the map to determine which item the cursor is sitting over. Then, when cursor is over an item for x time, then check if the zoom is on. If so, then the IPAD displays. The IPAD, for this purpose, is an item, with all the flexibility that entails.

Note that, for example, the zoom of an IPAD comprised of text may simply be presentation of that text in a larger font. Or it may mean treating the text as a graphic, and expanding it as a graphic image is expanded.

With the page stored as a series of objects as described above and further detailed below, data is updated by simply updating those objects that have changed. Component updating results in smaller updates than full page or document replacement—most often much of the content or format is retained with only minor changes required in making the document current. In addition to the data space saved by updating a limited number of components, the changes retrieved by the electronic publishing system are first compressed on the server side for minimal transfer time.

Process 702 FIG. 7 is for updating components. Step 704 is to maintain all data for an application on server. Step 706 institutes version control to recognize changes by giving each row on server table a version number. In step 708 each row (representing a component) is checked for update version level needed. Assuming that updating is needed, the updated information is compressed in step 710 and sent in step 712.

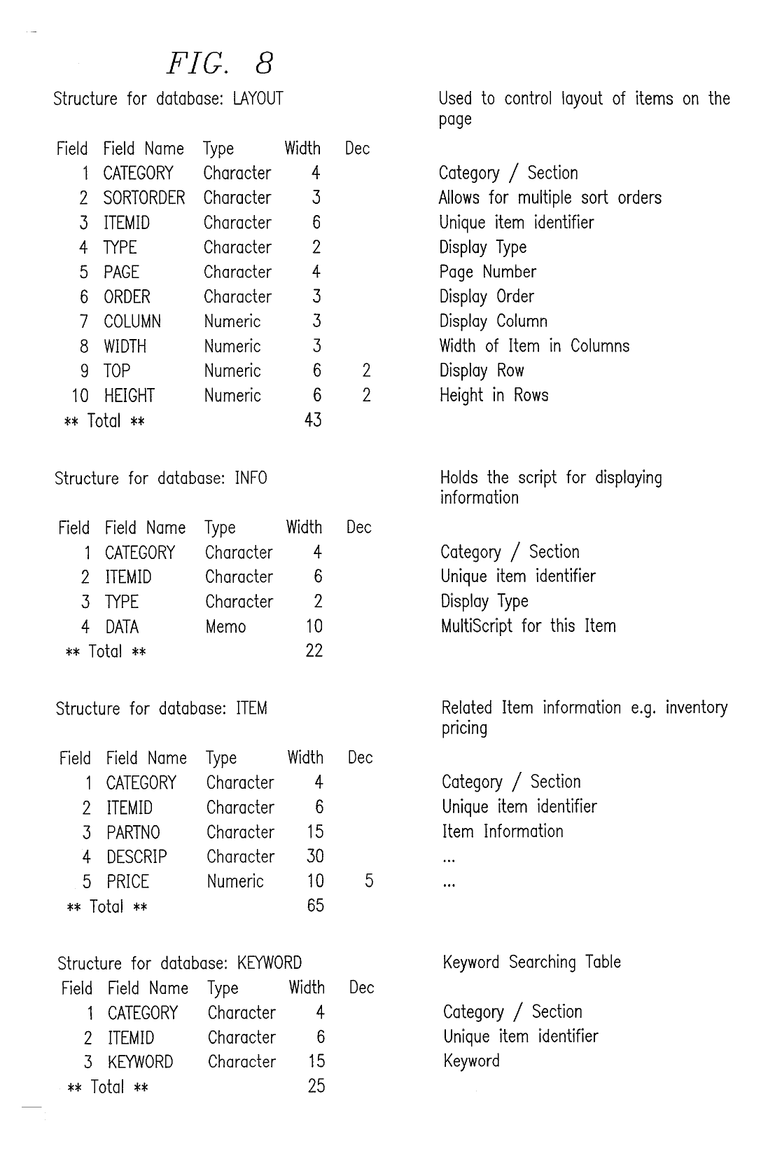

Database system 802 FIG. 8 is used for implementation of the electronic publishing system. Page layout table 804 controls where items appear on the page for onscreen viewing, and is created by the selected page assembly process. Item categorization table 806 (also called an “info table”) is the same as item categorization table 102 in FIG. 1, containing the same elements. Scripting can refer to data in an additional information table 808 (for example, including price information). This referencing might typically be done with pointers. Note that conceptually, there is nothing limiting the structure of the other table(s), so exploitation of superior live-access compression techniques would be possible.

Report table 810 controls where items appear on the page for printing. Key word table 812 is optional and cross references key words and items (items that are already assembled, not just info table elements). An example of an application might be to look up items matching “stereo.”

Note that items composing a custom item set can be created by virtually any criteria. An extended application of creating a custom item set to present to a user: rather than just showing the matching items, show the pages with the matching items and somehow graphically differentiate the matching items from the other items on the page. For example, decolorize non-matching items or “circle” matches with a marker graphic.

As types of data respond to compression differently, the disassembly of the page into objects allows each element to be compressed at the maximum level without compromising the display quality. The resulting page with this electronic publishing system is typically 20-50% (and sometimes as high as 95%) smaller than its equivalent HTML or PDF counterpart. This compression is accomplished through applying industry standard compression routines and eliminating much of the page format information from the content data. Other compression routines could be used. This reduced data size not only reduces transfer time but also reduces the costs of server processing and bandwidth.

In the item categorization table data, page-formatting information is eliminated to a large extent, allowing improved compression. Much of the page formatting information can be eliminated and still have conformation of the information to the desired format. The first factor is separation of objects by type. Second is the stripping out of page layout information.

Where an entire input page—including text—is stored as an image file, substantial compression is not available. This stems from the fact that lossy compression will quickly cause text to become unreadable.

As the electronic publishing system is contained in a software program it performs tasks on the user (client) computer reducing the task load for the server. In a standard HTML environment, each page viewed must be served up by the server, which demands large server capacity and a great deal of bandwidth. With the electronic publishing system, data is retrieved once. The client software has the intelligence to assemble and display additional pages as required. This is not analogous to the HTML-world action of downloading an entire web site so that future accessing will be local because the system goes beyond simple regurgitation. Possible differentiating actions include manipulation, resorting, etc. on data.

A “department store catalog” style document can be called a free form document or a print catalog. This style of document corresponds to a free form layout. Disassembly is manual as output data can only be built with manual intervention. Extraction is manual, as is creation of page layout information.

A “yellow pages” style document can be called a rule-based document or a display directory. This style of document corresponds to a rule-based layout. Disassembly is a mechanical process, extraction is manual, and creation of page layout information is automatic.

A “white pages” style document can be called a structured document or an information database. This style of document corresponds to a template layout. Disassembly is totally mechanical, extraction is automatic, and creation of page layout information is automatic.

Disassembly includes data elements and page layout information.

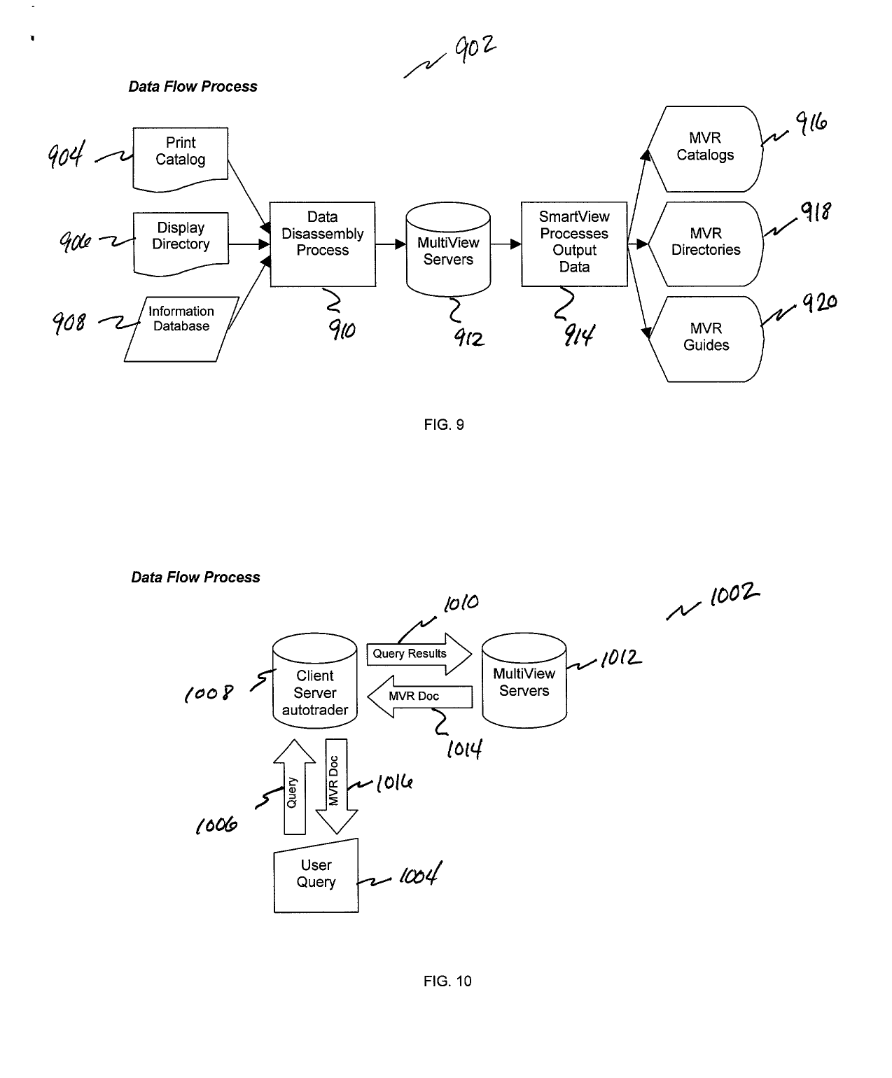

Process flow 902 FIG. 9 depicts a data flow process. Information from a print catalog 904, a display directory 906, or an information database 908 undergoes a data disassembly process 910. During data disassembly process 910, the data is reassembled into specialized data structures suitable for use as output data. Following data disassembly process 910, the output data is stored in server 912. As needed, output data is processed via electronic publishing system process 914. If the initial input was print catalog 904, then the final output is an MVR catalog 916. If the initial input was display directory 906, then the final output is an MVR directory 918. If the initial input was information database 908, then the final output is an MVR guide 920. The MVR catalog 916, MVR directory 918, and MVR guide 920 are MVR format files. They represent free form, rule-based, and structured documents, respectively.

The data disassembly process 910 could entail receiving data in purely electronic format, or could entail receiving printed documents and scanning the printed documents to convert them to electronic format. Data disassembly of a simple information database (“white pages” style document) only requires loading the data into specialized data structures. The data is picked up from the information database and placed into the specialized data structures without processing.

Data disassembly of a display directory (“yellow pages” style document) entails four steps. First receive the document in electronic format. Then extract display adds as images. Then receive database of names/addresses/categories. Finally, load names/addresses/categories just like for information database.

Data disassembly of a print catalog also requires four steps, although there are differences. First receive document in electronic format. Then extract images and text and page layout information (pagination, too). Then associate images, text, and page layout information appropriately to the extent that mechanical extraction has failed to do so. Finally, might have a price/items/inventory/part no/part description database to handle just like in the case of an information database.

The document servers might typically reside under centralized control, but could be located anywhere. MVR catalogs, directories, guides are simply examples of possible input/output document-types. Generally, the term “catalogs” is meant to include documents such as department store catalogs. Examples of “yellow pages” include yellow pages-type directory, Thomas registry, and some motel directories. Examples of “white pages” include auto trader, real estate books, some motel directories. However, it should be noted that context may make it apparent that the three document-types have been used interchangeably from time to time.

Generally any technology that attempts to duplicate the printed page on screen, using present day computers, must compromise the presentation in some way—scrolling the page, reducing content size or removing content from the page. To retain the integrity of the format without resorting to scrolling there must be a mechanism to reduce content on the page and preferably, a means to compensate for the missing information. Although other solutions may include components of an overall solution, it is difficult to envision a presentation interface that addresses not only the visual display, but also pagination, data compression and content updates without similar constructs. Other solutions may use entirely different database systems, page assembly methods and additional information ideology but it is reasonable to expect that there will be commonality in the underlying concepts.

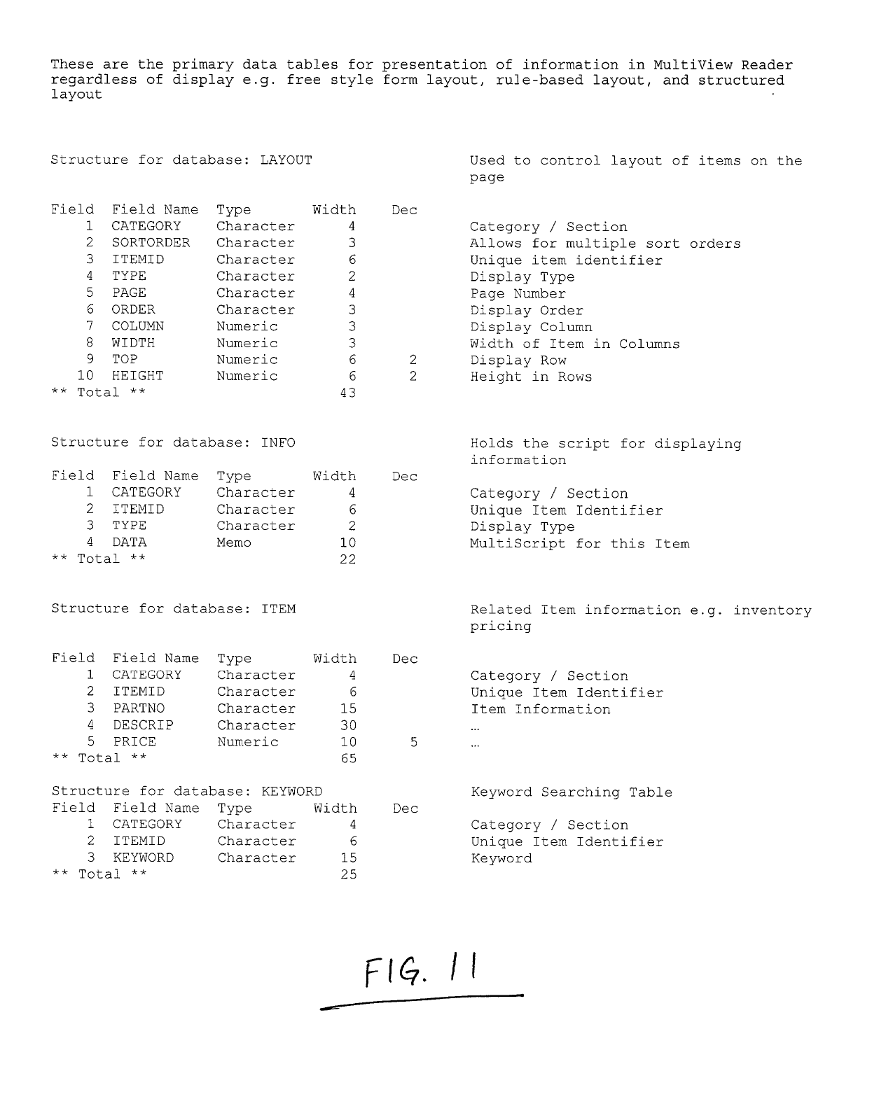

While the current implementation relies on assembling publications from queries to our database, we envision future uses where documents are assembled from outside data presented to our page assembly technology. For example, in process 1002 FIG. 10 a querying user 1004 sends a query 1006 to autotrader.com 1008 that yields a resulting set of matches 1010. The user may elect to view the information in MVR format—auto trader 1008 hands the data 1010 to MVR servers 1012, MVR 1012 hands back a prepared document 1014 to auto trader 1008. Auto trader 1008 then sends the MVR document 1016 corresponding to MVR document 1014 to the querying user 1004. The user views the information in their reader. Documents 1014 and 1016 are compressed, formatted, adaptive displays that are Internet aware and able to self-update at the user's option.

Alternative content in MVR files includes such information as names of people, addresses, phone numbers, item names, quantity of items per order unit, item descriptions, options, pricing, item numbers, contact information related to classified listings, etc.

A possible MVR file structure is depicted in FIG. 11. As noted, the MVR file format structure need not necessarily be different for representing free form, rule-based, and structured layouts. Four tables and their respective fields are enumerated on the left side of the figure, while the right side of the figure, commentary includes description of nearly each line item.

To summarize the hierarchy of potential user presentation limitations, the display device provides the ultimate outer bound of what can be seen at one time in terms of display capacity. The display window typically represents the next smaller potential outer bound on what is displayed to the user. However, as noted above, the display window may contain more information than the display device is able to display. But if the display window is configured to contain more information than the display device, then all of the information within the display window will not be able to be seen simultaneously on the display device in question. Within the display window is any restriction placed on the view by the electronic publishing application, and within that, any limitation specified by the user. Of course, the user will only be able to specify a limitation if allowed by a particular embodiment of the electronic publishing application.

The following guidelines indicate partial meanings of some terms as used herein, although none of these guidelines set forth the exclusive meaning of any term:

The term “network” refers to hardware and software data communication systems. Included in the meaning is a group of interconnected information handling systems such as computers and the communication channels which connect them.

The term “router” refers to a device that forwards packets between networks. The forwarding decision is based on network layer information and routing tables often constructed by routing protocols.

The term “internet” refers to any set of networks interconnected with routers. The term includes a network comprised of other networks.

The term “Internet” refers to the largest internet in the world. It is a three-level hierarchy composed of backbone networks, midlevel networks, and stub networks. These include commercial, university, and other research networks and military networks and span many different physical networks around the world with various protocols, chiefly the Internet Protocol.

The term “intranet” refers to any network which provides similar services within an organization to those provided by the Internet outside it but which is not necessarily connected to the Internet. May also be an internet or part of the Internet, for example. A common example is the use by a company of one or more web servers on an internal TCP/IP network for distribution of information within the company.

The term “extranet” refers to an intranet for which limited access has been granted to other organizations, the general public, or other entities other than the primary user of the intranet.

The term “World Wide Web” (Web, WWW) refers to an Internet client-server hypertext distributed information retrieval system. The Web is actually an Internet facility and is commonly used as a synonym for Internet. The Web has as its foundation the hypertext markup language (HTML) document, which contains links to URLs of other documents on the same web server or on servers anywhere in the world. The Web uses the hypertext transfer protocol (HTTP) to download web pages to a browser such as Netscape Navigator or Internet Explorer. Despite its intense use in conjunction with the Internet, Web technology is not limited to the Internet, being usable in internet and intranet settings, for example.

The term “uniform resource locator” (URL) refers to the address that defines the route to a file on the Web or any other internet facility. URLs may be typed into the browser to access web pages or embedded within web pages themselves to provide HTTP links to other pages.

The term “web server” refers to an information handling system that provides Web services on an internet. The term may refer to just the software that provides this service or to the computer system and hardware. A web server may host one or more websites which in turn are comprised of one or more web pages.

The term “web page” (page) refers to a computer-readable file.

The term “website” or “web site” (site) refers to a collection of web pages that are intended to be accessed via URLS embedded in an indexed page known as a home page.

A “web browser” (browser) refers to a program that serves as an interface to the Web and allows viewing of websites. In the most basic browsers, a user may type a URL into the browser's location field and the home page of that site is downloaded to the user's computer.

The term “communicably coupled” refers to any connection that is adapted to carry communication, whatever the supporting technology. It includes hard wire connections such as phone lines, T1 lines, DSL, fiber optic, etc. It also includes wireless connections adapted to carry communication such as via electromagnetic waves, wireless optics (e.g., infrared), etc. The technology by which the communication is transmitted is not material to the meaning of communicably coupled.

The term “computing device” includes a device having at least one central processing unit (CPU) and a memory device, wherein the CPU is adapted to process data that can be stored in the memory device before and/or after processing. Common examples of a computing device include personal computer, palm computing device, notebook computer, server, or mainframe. Also included within the definition of computing device is a system of multiple computers networked together such that processing and/or storage activities on the computers are coordinated. Also included in the definition of computing device is a system of devices networked together such that each device may not be a computer in its own right, but in combination, the networked devices achieve the functionality of a computer having at least one CPU and at least one memory device. For example, components of a computing device may be connected across the Internet.

The term “non-volatile storage” includes storage devices whose contents are preserved when their power is off. These devices are often used as secondary storage devices. Storage using magnetic media (e.g. magnetic disks, magnetic tape or bubble memory) is normally non-volatile by nature. Other examples of non-volatile storage include Bernoulli Box (trademark of Iomega Corporation), compact disc (CD), computer output on microfilm (COM), computer output on laser disk (COLD), digital audio tape (DAT), digital linear tape (DLT), digital versatile disk (DVD), electrically alterable programmable read-only memory (EAPROM), electrically erasable programmable read-only memory (EEPROM), erasable programmable read-only memory (EPROM), flash erasable programmable read-only memory (FEPROM), floppy disk, floptical, hard disk (removable or fixed), Jaz Drive (trademark of Iomega Corporation), JBOD, disk farm, magnetic disk, magnetic drum, optical disk, magneto-optical disk, one time programmable read-only memory (OTPROM or OTP), programmable read-only memory (PROM), tape drive, paper tape, and punch cards.

The term “volatile storage” includes storage devices whose contents are not ordinarily preserved when their power is off. Examples of volatile memory include semiconductor memories (static RAM and especially dynamic RAM), which are normally volatile but can be made into non-volatile storage by having a (rechargeable) battery or other uninterrupted power supply permanently connected. Dynamic RAM is particularly volatile since it loses its data, even if the power is still on, unless it is refreshed. An acoustic delay line is a (very old) example of a volatile storage device.

The term “memory device” includes all data storage devices, including nonvolatile, volatile, and other data storage devices.

The term “executing program” includes program code and some private data. The program code may be shared with other executing programs that are executing the same program code but may include different private data. An executing program may include other associated resources such as a process identifier, open files, CPU time limits, shared memory, child processes, and signal handlers. A multitasking operating system can run multiple executing programs concurrently or in parallel.

The term “database” includes one or more large structured sets of persistent data, usually associated with software to update and query the data.

The term “query” includes a user's (or agent's) request for information, generally as a formal request to a database or search engine. SQL is the most common database query language.

The term “distributed query” includes a query issued against data of multiple databases, wherein at least one of the databases resides on one machine and at least one other of the databases resides on a different machine. A distributed query includes a query that selects data from multiple databases, using, for example, joins, nested queries, or views.

The terms “structured query language” and “SQL” are equivalent and include a language which provides a user interface to relational database management systems, developed by IBM in the 1970s for use in System R. SQL is the de facto standard, as well as being an ISO and ANSI standard. It is often embedded in other programming languages. The first SQL standard, in 1986, provided basic language constructs for defining and manipulating tables of data; a revision in 1989 added language extensions for referential integrity and generalized integrity constraints. Another revision in 1992 provided facilities for schema manipulation and data administration, as well as substantial enhancements for data definition and data manipulation. Development is currently underway to enhance SQL into a computationally complete language for the definition and management of persistent, complex objects. This includes: generalization and specialization hierarchies, multiple inheritance, user defined data types, triggers and assertions, support for knowledge based systems, recursive query expressions, and additional data administration tools. It also includes the specification of abstract data types (ADTs), object identifiers, methods, inheritance, polymorphism, encapsulation, and all of the other facilities normally associated with object data management.

The term “server” refers to a computing device connected to a network. Typically, a server sends information to other computing devices through the network. The information might be data or commands from or to an executing application. The network might be an intranet, the Internet, or some other network.

The term “vector graphic” or “vector drawing” include a dealing with separate shapes such as points, edges, and groups of such objects as contrasted, for example, with a paint-type program that deals with shapes in terms of bitmaps. The advantage of a vector drawing is that it is possible to change any element of the picture at any time since each part is stored as an independent object whereas once something in a bitmap has been overwritten it cannot in general be retrieved.

The term “MVR document” refers to a collection of substantially all data elements needed in order to present content to a display device. For example, the MVR document may include a single file or a collection of files containing the needed information. The needed information may vary depending upon the capacity of the display device. The needed information may vary if some of the information that would otherwise be needed information were contained in close proximity to the display device. For example, the proximate information might be stored locally on the computing device of which the display device is part. For example . . .

The terms “MVR catalog,” “MVR directory,” and “MVR guide” each refer to possible input/output document types. The terms correspond to MVR documents in that MVR documents represent encoded information whereas these terms represent decoded information. An MVR catalog represents a free form document, an MVR directory represents a structured display document, and an MVR guide represents a structured document.

The term “graphic object” refers to a non-text visual object. Examples of file formats included in this meaning are BMP, GIF, JPG, TIFF, and PNG.

The term “logical object” refers to a logically distinct manipulatable object. Examples of logical objects might include graphic objects, text objects, hyperlink, etc.

The term “item” refers to a set of one or more logical objects. An item may be one or more graphic objects, one or more textual objects, or a combination of one or more graphic objects and one or more textual objects.

The term “display window” refers to a window to which the electronic publishing application is given access. Limitation of the application to the display window may be imposed by hardware or software factors. For example, Microsoft® Windows® (version 2000, as well as other versions) uses display windows for each instantiated application. Note that the display window may be smaller than, the same size as, or larger than the display device used by the user. UNIX operating systems are better known for their use of display windows larger than the display device being used. In the case of a display window larger than the display device being used, the entire display window cannot be seen at once by the user, requiring jumping, scrolling, or some other mechanism to visit all parts of the display window. The display window may also be “self limited” meaning that the electronic publishing application may limit the size of the display window either through design of the application, an option set by the user, or other mechanism.

The term “virtual canvas” refers to the logical composite object created by disposition of one or more items. A virtual canvas is sometimes referred to as a “page” or “screen.”

The term “filly exploit” as applied to formatting and positioning of one or more items with regard to a display window (or analogously to one or more logical objects with regard to an item) refers to stretching and disposing items so as to make maximum usage of the display window. For example, if the items are arranged and disposed satisfactorily except for the fact that the virtual canvas only fills a quarter of the display window, then the virtual canvas will be stretch drawn such that the virtual canvas (scaled) will be twice the length and twice the height of the virtual canvas (unscaled). Alternatively, if items could be abbreviated in several different ways and to several different extents, then that abbreviation that will not leave a significant portion of the display window unused will be selected. An additional view of full exploitation might be that where the capacity of an information outlet is greater than the granularity of some information to be presented through that information outlet, then the information outlet has not been fully exploited.

The term “overload” as applied to formatting and positioning of one or more items with regard to a display window (or analogously to one or more logical objects with regard to an item) refers to stretching and disposing items so as to avoid over crowding, over reducing, over abbreviating, or otherwise substantially compromising the effective usability of items by including too many items on one virtual canvas. For example, if either two or four items could be included on a virtual canvass, and including four items would cause one or more of the aforementioned problems, or any other problem substantially compromising the usability of one or more of those four items, then the disposition of two items on the virtual canvas will be selected. An additional view of overloading might be that where the capacity of some information outlet is lesser than the amount of some information to be presented through that information outlet, then the information outlet has been overloaded.

The term “display item” refers to an atomic group. That is, text and/or graphic elements of an item combine to form the item in such a way that their position in relation to each other is significant and would not be altered without changing the impact of the item as an element of communication.

The term “display device” refers to a device adapted to present sensory output according to and controlled by a computing device to which the display device is communicably coupled. The sensory output may include visual, audio, and/or other output.

The term “granularity” refers to the information density of output. For example, in the case of visual output, granularity might be represented by pixel height×pixel width.

The term “page assembly logic” includes logical rules that specify the organization of items. Examples of page assembly logic include logic directed to free form layout, rule-based layout, and/or structured layout.

Any element in a claim that does not explicitly state “means for” performing a specified function, or “step for” performing a specific function, is not to be interpreted as a “means” or “step” clause as specified in 35 U.S.C. § 112, ¶ 6. In particular, the use of “step of” in the claims herein is not intended to invoke the provision of 35 U.S.C. § 112, ¶ 6.

It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

What is claimed is:

1. A method of electronically publishing information comprising:
(a) transforming the information into an MVR document;
(b) storing the MVR document on a document server; and
(c) sending the MVR document to a recipient.

2. The method of claim 1,
(a) wherein receiving information comprises receiving information having a free form layout; and
(b) wherein transforming the information into an MVR document comprises transforming the information into an MVR document representing an MVR catalog.

3. The method of claim 2, wherein transforming the information into an MVR document comprises:
(a) disassembling the information into distinct items;
(b) extracting position, size, and context of the items; and
(c) reassembling the captured items to create MVR page layout information.

4. The method of claim 3, wherein
(a) the disassembling is manual;
(b) the extracting is manual; and
(c) the reassembling is manual.

5. The method of claim 1,
(a) wherein receiving information comprises receiving information having a rule-based layout; and
(b) wherein transforming the information into an MVR document comprises transforming the information into an MVR document representing an MVR directory.

6. The method of claim 5, wherein transforming the information into an MVR document comprises:
(a) designating display rules that define the structured presentation of structured content;
(b) disassembling the information into distinct items;
(c) extracting the position, size, and context of the items; and
(d) reassembling the captured items to create MVR page layout information.

7. The method of claim 6, wherein
(a) the disassembling is systematic;
(b) the extracting is manual; and
(c) the reassembling is systematic.

8. The method of claim 1,
(a) wherein receiving information comprises receiving information having a structured layout; and
(b) wherein transforming the information into an MVR document comprises transforming the information into an MVR document representing an MVR guide.

9. The method of claim 8, wherein transforming the information into an MVR document comprises:
(a) disassembling the information to capture position, size, and context of all items represented in the information; and
(b) reassembling the captured items to create MVR page layout information.

10. The method of claim 9, wherein
(a) the disassembling is systematic;
(b) the extracting is systematic; and
(c) the reassembling is systematic.

11. A method of electronically publishing information comprising:
(a) transforming the information into an MVR document;
(b) storing the MVR document.

12. The method of claim 11, wherein the MVR document is adapted to be displayed, wherein the displayed MVR document is adapted to have substantially the same look and feel as the information.

13. The method of claim 11,
(a) wherein the information comprises a representation of a free form layout; and
(b) wherein transforming the information into an MVR document comprises transforming the information into an MVR document representing an MVR catalog.

14. The method of claim 13, wherein transforming the information into an MVR document comprises:
(a) identifying an item, the item comprising:
(i) a position;
(ii) content;
(iii) a size; and
(iv) a context; and
(b) assembling the items to create MVR page layout information.

15. The method of claim 14, wherein
(a) the identifying is manual; and
(b) the assembling is manual.

16. The method of claim 15, wherein the MVR page layout information is adapted to be displayed having substantially the same look and feel as the information.

17. The method of claim 15, further comprising:
(a) reading in the information from a data file.

18. The method of claim 17, wherein the data file comprises an MVR format file.

19. The method of claim 17, wherein the data file comprises a PDF format file.

20. The method of claim 17, wherein the data file comprises a desktop publishing format file.

21. The method of claim 15, further comprising:
(a) designating whether the item will be included in the MVR page layout information.

22. The method of claim 21, wherein the designating is based on whether specific features characterize the item.

23. The method of claim 11,
(a) wherein the information comprises a representation of a rule-based layout; and
(b) wherein transforming the information into an MVR document comprises transforming the information into an MVR document representing an MVR directory.

24. The method of claim 23, wherein transforming the information into an MVR document comprises:
(a) identifying an item, the item comprising:
(i) a size; and
(ii) content;
(b) designating display rules that define the structured presentation of structured content, wherein the display rules comprise:
(i) a position;
(ii) a context; and
(c) disposing the item based on the display rules to create MVR page layout information.

25. The method of claim 24, further comprising:
(a) reading in the information from a data file.
(b) inferring display rules based on the information read in from the data file;

26. The method of claim 25, further comprising:
(a) requesting input representing approval/disapproval of the display rules; and
(b) if disapproval is returned, then requesting display rules.

27. The method of claim 24, wherein
(a) the designating is manual;
(b) the identifying is manual; and
(c) the assembling is systematic.

28. The method of claim 27, wherein the MVR page layout information is adapted to be displayed having substantially the same look and feel as the information.

29. The method of claim 27, further comprising:
(a) reading in the information from a data file.

30. The method of claim 29, wherein the data file comprises an MVR format file.

31. The method of claim 29, wherein the data file comprises a PDF format file.

32. The method of claim 29, wherein the data file comprises a desktop publishing format file.

33. The method of claim 29, further comprising:
(a) reading in display rules from a display rules file; and
(b) wherein the display rules file is distinct from the data file.

34. The method of claim 27, further comprising:
(a) designating whether the item will be included in the MVR page layout information.

35. The method of claim 34, wherein the designating is based on whether specific features characterize the item.

36. The method of claim 11,
(a) wherein the information comprises a representation of a structured layout; and
(b) wherein transforming the information into an MVR document comprises transforming the information into an MVR document representing an MVR guide.

37. The method of claim 36, wherein transforming the information into an MVR document comprises:
(a) identifying a plurality of items, each item comprising:
(i) content
(ii) a size; and
(b) assembling the items to create MVR page layout information.

38. The method of claim 37, wherein
(a) the identifying is systematic; and
(b) the assembling is systematic.

39. The method of claim 38, wherein the MVR page layout information is adapted to be displayed having substantially the same look and feel as the information.

40. The method of claim 38, further comprising:
(a) designating whether the item will be included in the MVR page layout information.

41. The method of claim 40, wherein the designating is based on whether specific features characterize the item.

42. The method of claim 38, further comprising:
(a) reading in the information from a data file.

43. The method of claim 42, wherein the data file comprises an MVR format file.

44. The method of claim 42, wherein the data file comprises a PDF format file.

45. The method of claim 42, wherein the data file comprises a desktop publishing format file.

46. The method of claim 11, further comprising:
(a) reading in the information from a data file.

47. The method of claim 46, further comprising:
(a) inferring relationship and structure rules; and
(b) associating the relationship and structure rules with the information for subsequent disposition in the MVR document.

48. The method of claim 46, wherein the data file comprises an MVR format file.

49. The method of claim 46, wherein the data file comprises a PDF format file.

50. The method of claim 46, wherein the data file comprises a desktop publishing format file.

51. A method of displaying electronic information in a display window on a display device, the method comprising:
(a) providing on page information (ONPI);
(b) providing in page additional detail (IPAD);
(c) providing an IPAD zone;
(d) providing an IPAD zone trigger;
(e) assigning an IPAD display to the IPAD zone, wherein the IPAD display comprises the IPAD;
(f) displaying the ONPI in the display window;
(g) actuating the IPAD zone trigger; and
(h) displaying the IPAD display responsively to actuating the first IPAD zone trigger.

52. The method of claim 51, wherein ONPI comprises:
(a) on page text (ONPT); and
(b) on page graphics (ONPG).

53. The method of claim 51, wherein IPAD comprises:
(a) off page text (OFPT); and
(b) off page graphics (OFPG).

54. The method of claim 51,
(a) wherein ONPI comprises:
(i) on page text (ONPT); and
(ii) on page graphics (ONPG); and
(b) wherein IPAD comprises:
(i) off page text (OFPT); and
(ii) off page graphics (OFPG).

55. The method of claim 54, wherein the OFPG comprises a zoomed view of the ONPG displayed in the IPAD zone.

56. The method of claim 54, wherein OFPG comprises a zoomed view of a subsection of the ONPG displayed in the IPAD zone.

57. The method of claim 54, wherein OFPG comprises a zoomed view of information related to the ONPG displayed in the IPAD zone.

58. The method of claim 54, wherein OFPG comprises a zoomed view of information unrelated to the ONPG displayed in the IPAD zone.

59. The method of claim 54, wherein the ONPG maintain a substantially constant size ratio with regard to the display window.

60. The method of claim 54, wherein
(a) if the IPAD contains information duplicative of information in ONPI, then the duplicative information is stored by reference, wherein total storage requirements are reduced.

61. The method of claim 54, wherein the ONPG comprises a display item.

62. The method of claim 51,
(a) further comprising:
(i) providing a cursor;
(ii) designating a time delay; and
(b) wherein actuating the IPAD trigger comprises:
(i) positioning the cursor over the IPAD zone for a period of time at least as lengthy as the time delay.

63. The method of claim 62, wherein the cursor is substantially unmoving while being positioned over the trigger zone for a period of time at least as lengthy as the time delay.

64. The method of claim 62, wherein graphic objects of the ONPI maintain a substantially constant size ratio with regard to the display window.

65. The method of claim 62, wherein the IPAD comprises a zoomed view of the ONPI displayed in the IPAD zone.

66. The method of claim 62, wherein the IPAD comprises a zoomed view of a subsection of the ONPI displayed in the IPAD zone.

67. The method of claim 62, wherein the IPAD comprises a zoomed view of information related to the ONPI displayed in the IPAD zone.

68. The method of claim 62, wherein the IPAD comprises a zoomed view of information unrelated to the ONPI displayed in the IPAD zone.

69. The method of claim 62, wherein
(a) if the IPAD contains information duplicative of information in ONPI, then the duplicative information is stored by reference, wherein total storage requirements are reduced.

70. The method of claim 62, further comprising:
(a) locking the IPAD display on, the locking being responsive to left clicking in the IPAD zone while the IPAD display is visible; and
(b) ceasing to display the IPAD display, responsively to the cursor moving out of the IPAD zone, if the IPAD display is not locked.

71. The method of claim 51,
(a) further comprising:
(i) providing a cursor; and
(b) wherein actuating the IPAD trigger comprises:
(i) right clicking when the cursor is over the IPAD zone.

72. The method of claim 71, wherein ONPI comprises:
(a) on page text (ONPT); and
(b) on page graphics (ONPG).

73. The method of claim 71, wherein IPAD comprises:
(a) off page text (OFPT); and
(b) off page graphics (OFPG).

74. The method of claim 71,
(a) wherein ONPI comprises:
(i) on page text (ONPT); and
(ii) on page graphics (ONPG); and
(b) wherein IPAD comprises:
(i) off page text (OFPT); and
(ii) off page graphics (OFPG).

75. The method of claim 74, wherein the ONPG comprises a display item.

76. The method of claim 51,
(a) further comprising:
(i) providing optional information (OPPI);
(ii) displaying the OPPI in the display window with the ONPI, provided that the display window has capacity to display the OPPI in addition to the ONPI; and
(b) wherein:
(i) if the display window lacks capacity to display the OPPI in addition to the ONPI, then the display IPAD further comprises the OPPI.

77. The method of claim 76, further comprising:
(a) locking the IPAD display on, the locking being responsive to left clicking in the IPAD zone while the IPAD display is visible; and
(b) ceasing to display the IPAD display, responsively to the cursor moving out of the IPAD zone, if the IPAD display is not locked.

78. The method of claim 51,
(a) further comprising:
(i) providing optional information (OPPI);
(ii) displaying the OPPI in the display window with the ONPI, provided that the display window has capacity to display the OPPI in addition to the ONPI;
(b) wherein:
(i) if the display window lacks capacity to display the OPPI in addition to the ONPI, then the display IPAD further comprises the OPPI; and
(c) wherein the size and shape of the display window is equal to the size and shape of the display device.

79. The method of claim 51, wherein the size and shape of the display window is equal to the size and shape of the display device.

80. The method of claim 51, wherein graphic objects of the ONPI maintain a substantially constant size ratio with regard to the display window.

81. The method of claim 51, wherein the IPAD comprises a zoomed view of the ONPI displayed in the IPAD zone.

82. The method of claim 51, wherein the IPAD comprises a zoomed view of a subsection of the ONPI displayed in the IPAD zone.

83. The method of claim 51, wherein the IPAD comprises a zoomed view of information related to the ONPI displayed in the IPAD zone.

84. The method of claim 51, wherein the IPAD comprises a zoomed view of information unrelated to the ONPI displayed in the IPAD zone.

85. The method of claim 51, wherein
(a) if the IPAD contains information duplicative of information in ONPI, then the duplicative information is stored by reference, wherein total storage requirements are reduced.

86. The method of claim 51, further comprising:
(a) locking the IPAD display on, the locking being responsive to left clicking in the IPAD zone while the IPAD display is visible; and
(b) ceasing to display the IPAD display, responsively to the cursor moving out of the IPAD zone, if the IPAD display is not locked.

87. A method of displaying electronic information in a display window on a display device, the method comprising:
(a) providing on page information (ONPI);
(b) providing in page additional detail (IPAD), wherein the IPAD comprises related information;
(c) providing an IPAD zone;
(d) providing an IPAD zone trigger;
(e) assigning an IPAD display to the IPAD zone, wherein the IPAD display comprises the IPAD;
(f) displaying the ONPI in the display window;
(g) actuating the IPAD zone trigger; and
(h) displaying the IPAD display responsively to actuating the first IPAD zone trigger.

88. A method of displaying electronic information in a display window on a display device, the method comprising:
(a) providing on page information (ONPI);
(b) providing in page additional detail (IPAD), wherein the IPAD comprises a graphic object;
(c) providing an IPAD zone;
(d) providing an IPAD zone trigger;
(e) assigning an IPAD display to the IPAD zone, wherein the IPAD display comprises the IPAD;
(f) displaying the ONPI in the display window;
(g) actuating the IPAD zone trigger; and
(h) displaying the IPAD display responsively to actuating the first IPAD zone trigger.

89. The method of claim 88, wherein the graphic object comprises a display item.

90. The method of claim 89, wherein the IPAD zone trigger is adapted to be toggled “on” and “off” by right clicking.

91. A method of assembling information in a display window on a display device,
(a) the method comprising:
(i) providing an item comprising a logical object;
(ii) disposing the logical object within the item; and
(iii) positioning the item in the display window based on page assembly logic and the capacity of the display window;
(b) wherein the disposing and positioning fully exploit the capacity of the display window; and
(c) wherein the disposing and positioning do not overload the capacity of the display window.

92. The method of claim 91, wherein the logical object maintains a substantially constant size ratio with regard to the item.

93. The method of claim 91, wherein the item maintains a substantially constant size ratio with regard to the display window.

94. The method of claim 91,
(a) wherein the item has rectangular shape;
(b) wherein the item comprises:
(i) a graphic object; and
(ii) a text object; and
(c) wherein the item maintains a substantially constant size ratio with regard to the display window.

95. The method of claim 91,
(a) wherein the item has rectangular shape;
(b) wherein the item comprises:
(i) a graphic object; and
(ii) a text object; and
(c) wherein the graphic object maintains a substantially constant size ratio with regard to the item.

96. The method of claim 91, wherein the logical object is disposed in the item such that the item is characterized by a free form layout.

97. The method of claim 91, wherein the logical object is disposed in the item such that the item is characterized by a rule-based layout.

98. The method of claim 91, wherein the logical object is disposed in the item such that the item is characterized by a structured layout.

99. The method of claim 91, further comprising:
(a) formatting the item based on the capacity of the display window;

100. The method of claim 91, wherein the item has rectangular shape.

101. The method of claim 91, wherein the item comprises a graphic object.

102. The method of claim 91, wherein the item comprises a text object.

103. The method of claim 91, wherein the item comprises:
(a) a graphic object; and
(b) a text object.

104. The method of claim 91, wherein the position of logical objects is specified in a scripting screen control language.

105. The method of claim 91, wherein the position of the item is specified in a scripting screen control language.

106. The method of claim 91, wherein the page assembly logic is directed to free form layout.

107. The method of claim 91, wherein the page assembly logic is directed to rule-based layout.

108. The method of claim 91, wherein the page assembly logic is directed to structured layout.

109. The method of claim 91, wherein disposing the logical object comprises:
(a) designating a designated position for the logical object; and
(b) positioning the logical object according to the designated position.

110. The method of claim 91,
(a) wherein the logical object comprises a graphic object;
(b) wherein disposing the logical object comprises:
(i) specifying a top left corner point; and
(ii) positioning the logical object according to the top left corner point.

111. The method of claim 110,
(a) wherein the logical object comprises a graphic object;
(b) wherein designating a designated position comprises:
(i) specifying a top left corner point;
(ii) specifying a height; and
(iii) specifying a width; and
(c) wherein the designated position comprises:
(i) the top left corner point;
(ii) the height; and
(iii) the width.

112. The method of claim 110,
(a) wherein the logical object comprises a text object;
(b) wherein designating a designated position comprises:
(i) specifying an x-y starting coordinate; and
(c) wherein the designated position comprises:
(i) the x-y starting coordinate.

113. The method of claim 110,
(a) wherein the logical object comprises a text object;
(b) wherein designating a designated position comprises:
(i) specifying an x-y starting coordinate;
(ii) specifying a justification; and
(iii) specifying a text margin; and
(c) wherein the designated position comprises:
(i) the x-y starting coordinate;
(ii) the justification; and
(iii) the text margin.

114. The method of claim 110,
(a) wherein the logical object comprises a vector drawing;
(b) wherein designating a designated position comprises:
(i) specifying the positions of a plurality of points;
(ii) specifying the positions of a plurality of edges, wherein each point comprises an endpoint of at least one of the edges, and wherein each endpoint of each edge comprises one of the points; and
(c) wherein the designated position comprises:
(i) an orientation of the vector drawing corresponding to the positions of the points and the positions of the edges.

115. The method of claim 91, wherein positioning the item in the display window based on page assembly logic and the capacity of the display window comprises:
(a) positioning the item on a virtual canvas based on page assembly logic and the capacity of the display window; and
(b) presenting the virtual canvas in the display window.

116. The method of claim 115, wherein the virtual canvas is adapted to be displayed in the display window having substantially the same look and feel as the information.

117. The method of claim 115, wherein the virtual canvas is adapted to be displayed in the display window having substantially the same look and feel as the information.

118. The method of claim 115, wherein the virtual canvas is assembled substantially immediately before being displayed in the display window.

119. The method of claim 115, further comprising:
(a) formatting the logical object based on the capacity of the display window; and
(b) presenting the virtual canvas, as a single graphic image, in the display window;

120. The method of claim 115, further comprising:
(a) presenting the virtual canvas, as a single graphic image, in the display window;

121. The method of claim 115, wherein the virtual canvas is assembled at a time substantially preceding being displayed in the display window.

122. The method of claim 121, wherein the virtual canvas is stored on a memory device.

123. The method of claim 91,
(a) wherein the item has rectangular shape;
(b) wherein the item comprises:
(i) a graphic object; and
(ii) a text object; and
(c) wherein the position of logical objects is specified in a scripting screen control language.

124. The method of claim 123, wherein the virtual canvas is assembled substantially immediately before being displayed in the display window.

125. The method of claim 123, wherein the virtual canvas is assembled at a time substantially preceding being displayed in the display window.

126. The method of claim 91,
(a) wherein the item has rectangular shape; and
(b) wherein the item comprises:
(i) a graphic object; and
(ii) a text object.

127. The method of claim 126, wherein the logical object is disposed in the item such that the item is characterized by a free form layout.

128. The method of claim 126, wherein the logical object is disposed in the item such that the item is characterized by a rule-based layout.

129. The method of claim 126, wherein the logical object is disposed in the item such that the item is characterized by a structured layout.

130. The method of claim 126, wherein the graphic object comprises a display item.

131. The method of claim 126,
(a) wherein disposing the logical object within the item comprises disposing the logical object within the item based on the other logical objects associated with the same item; and
(b) wherein positioning the item in the display window based on page assembly logic and capacity of the display window comprises positioning the item in the display window based on:
(i) page assembly logic;
(ii) capacity of the display window; and
(iii) the other items.

132. The method of claim 131, further comprising:
(a) reading in the information from a data file.

133. The method of claim 132, wherein the data file comprises an MVR format file.

134. The method of claim 132, wherein the data file comprises a PDF format file.

135. The method of claim 132, wherein the data file comprises a desktop publishing format file.

136. A method of displaying electronic information in a display window on a display device, the method comprising:
(a) providing on page information (ONPI);
(b) providing in page additional detail (IPAD);
(c) providing an IPAD zone;
(d) providing an IPAD zone trigger;
(e) assigning an IPAD display to the IPAD zone, wherein the IPAD display comprises the IPAD;
(f) displaying the ONPI in the display window;
(g) providing an IPAD toggle, wherein the IPAD toggle may be “on” or “off;”
(h) actuating the IPAD zone trigger; and
(i) displaying the IPAD display responsively to actuating the first IPAD zone trigger, if the IPAD toggle is “on.”

137. The method of claim 136,
(a) wherein ONPI comprises:
(i) on page text (ONPT); and
(ii) on page graphics (ONPG); and
(b) wherein IPAD comprises:
(i) off page text (OFPT); and
(ii) off page graphics (OFPG).

138. The method of claim 136, further comprising:
(a) locking the IPAD display on, the locking being responsive to left clicking in the IPAD zone while the IPAD display is visible.

139. The method of claim 136, further comprising:
(a) locking the IPAD display on, the locking being responsive to left clicking in the IPAD zone while the IPAD display is visible; and
(b) ceasing to display the IPAD display, responsively to the cursor moving out of the IPAD zone, if the IPAD display is not locked.

140. The method of claim 136,
(a) further comprising:
(i) providing a cursor;
(ii) designating a time delay; and
(b) wherein actuating the IPAD trigger comprises:
(i) positioning the cursor over the IPAD zone for a period of time at least as lengthy as the time delay.

141. The method of claim 140, further comprising:
(a) locking the IPAD display on, the locking being responsive to left clicking in the IPAD zone while the IPAD display is visible; and
(b) ceasing to display the IPAD display, responsively to the cursor moving out of the IPAD zone, if the IPAD display is not locked.

142. The method of claim 140, further comprising:
(a) setting the IPAD toggle to “off” responsively to right clicking the cursor, if the IPAD toggle is set to “on;”
(b) setting the IPAD toggle to “on” responsively to right clicking the cursor, if the IPAD toggle is set to “off.”

143. The method of claim 142, further comprising:
(a) locking the IPAD display on, the locking being responsive to left clicking in the IPAD zone while the IPAD display is visible.

144. The method of claim 142, further comprising:
(a) locking the IPAD display on, the locking being responsive to left clicking in the IPAD zone while the IPAD display is visible; and
(b) ceasing to display the IPAD display, responsively to the cursor moving out of the IPAD zone, if the IPAD display is not locked.

145. A method of updating a first data table,
(a) wherein the first data table is in MVR format;
(b) wherein the first data table is adapted for use with an electronic publishing application;
(c) wherein a first row version is associated with a first row of the first data table;
(d) wherein the updating occurs based on a second data table in MVR format;
(e) wherein a second row version is associated with a second row of the second data table; and
(f) wherein the method comprises:
(i) comparing the first row version to the second row version; and
(ii) if the first row version is older than the second row version, then updating the first row based on the second row.

146. The method of claim 145, wherein the data table is maintained on a server.

147. The method of claim 146, wherein the first data table is communicably coupled to the second data table.

148. The method of claim 146, wherein the first data table is communicably coupled to the second data table via a network.

149. The database system of claim 148, wherein the network comprises the Internet.

150. The database system of claim 148, wherein the network comprises an intranet.

151. A database system adapted for use in electronic publishing,
(a) the database system comprising:
(i) a layout table, wherein the layout table controls disposition of items in the display window;
(ii) an item categorization table,
(1) wherein the item categorization table comprises:
(A) an on page graphic category;
(B) an off page graphic category;
(C) an on page text category;
(D) an off page text category;
(E) an optional text category; and
(F) a related information category; and
(2) wherein the item categorization table is operably coupled to the layout table;
(iii) an additional information table
(1) adapted to be referenced by script references;
(2) wherein the additional information table is operably coupled to the layout table; and
(3) wherein the additional information table is operably coupled to the item categorization table; and
(iv) a report table adapted to control placement of items in the display window for printing.

152. The database system of claim 151, wherein items of each category are compressed separately, whereby degree of compression is typically improved.

153. The database system of claim 151, further comprising a key word table, wherein the key word table is adapted to associate an item and a word, such that a query directed to the word returns identifying information for the item.

154. The database system of claim 153,
(a) further comprising an overall computing device, the overall computing device comprising:
(i) a first computing device; and
(ii) a second computing device, wherein the second computing device is communicably coupled to the first computing device;
(b) wherein the additional information table is located on the first computing device;
(c) wherein the layout table is located on the overall computing device;
(d) wherein the item categorization table is located on the overall computing device;
(e) wherein the report table is located on the overall computing device; and
(f) wherein the key word table is located on the overall computing device.

155. The database system of claim 151,
(a) further comprising an overall computing device, the overall computing device comprising:
(i) a first computing device; and
(ii) a second computing device, wherein the second computing device is communicably coupled to the first computing device;
(b) wherein the additional information table is located on the first computing device;
(c) wherein the layout table is located on the overall computing device;
(d) wherein the item categorization table is located on the overall computing device; and
(e) wherein the report table is located on the overall computing device.

156. The database system of claim 155, wherein the second computing device uses a web browser as a usability gateway to the communicable coupling between the first computing device and the second computing device.

157. A system to provide MVR documents,
(a) the system comprising:
(i) a first computing device; and
(ii) a second computing device, wherein the second computing device is communicably coupled to the first computing device;
(b) wherein the first computing device is adapted to transmit provided data to the second computing device;
(c) wherein the second computing device is adapted to process information from provided data into MVR format data; and
(d) wherein the second computing device is adapted to transmit MVR format data to the first computing device.

158. The method of claim 157,
(a) wherein the first computing device is adapted to create, from MVR format data, a virtual canvas according to the capacity of a particular display device.

159. A method of providing MVR documents,
(a) the method comprising:
(i) transmitting provided data from a first computing device to a second computing device that is communicably coupled to the first computing device; and
(ii) receiving MVR format data by the first computing device from the second computing device; and
(b) wherein the MVR format data is adapted to be utilized in displaying an image
(i) containing content information equivalent to content information in the provided data, the content information being based on the content information in the provided data;
(ii) conforming to display rules based on the provided data, if the provided data is in a rule-based layout; and
(iii) conforming to layout information based on the provided data, if the provided data is in a free form layout.

160. The method of claim 159, wherein the MVR format data is adapted to display an IPAD based on the provided data.

161. An MVR document server,
(a) the MVR document server comprising:
(i) a first computing device, the first computing device being communicably coupled to a network;
(b) wherein the first computing device is adapted to receive provided data from a second computing device through the network;
(c) wherein the first computing device is adapted to process information from provided data into an MVR document; and
(d) wherein the first computing device is adapted to transmit the MVR document to the second computing device through the network.

162. An MVR document server,
(a) the MVR document server comprising:
(i) a first computing device, the first computing device being communicably coupled to a network;
(b) wherein the first computing device is adapted to receive provided data from a second computing device through the network;
(c) wherein the first computing device is adapted to process information from provided data into an MVR document;
(d) wherein the first computing device is adapted to process an MVR document to be displayable in a display window on a particular display device; and
(e) wherein the first computing device is adapted to transmit the MVR document to the second computing device through the network.

163. The MVR document server of claim 162, wherein the particular display device is a palm computing device.

164. An MVR document serving system,
(a) the MVR document server comprising:
(i) a first computing device; and
(ii) a second computing device, the second computing device being communicably coupled to the first computing device via a network;
(b) wherein the first computing device is adapted to receive provided data from the second computing device;
(c) wherein the first computing device is adapted to process information from provided data into an MVR document;
(d) wherein the first computing device is adapted to process an MVR document to be displayable a particular display device; and
(e) wherein the first computing device is adapted to transmit the MVR document to the second computing device through the network.

165. The MVR document serving system of claim 164,
(a) wherein the particular display device is operably coupled to the second computing device.

166. A method of electronic publishing,
(a) the method comprising:
(i) receiving content information formatted for display through a first medium;
(ii) displaying the content information through a second medium comprising a display device;
(b) wherein the displayed content information has substantially the same look and feel as the content information to the extent possible as limited by page assembly logic and capacity of the display device.
